(19) United States
(12) Patent Application Publication
(10) Pub. No.: US 2023/0259765 A1
(43) Pub. Date: Aug. 17, 2023

(54) SYSTEM AND METHOD FOR STRUCTURING A TENSOR NETWORK

(71) Applicant: Intel Corporation, Santa Clara, CA (US)

(72) Inventors: Nicolas Sawaya, San Francisco, CA (US); Subrata Goswami, Milpitas, CA (US); Christopher Hughes, Santa Clara, CA (US)

(73) Assignee: Intel Corporation, Santa Clara, CA (US)

(21) Appl. No.: 18/056,331

(22) Filed: Nov. 17, 2022

(51) Int. Cl. G06N 3/08

(52) U.S. Cl. CPC G06N 3/08

(57) ABSTRACT

An agent trained using reinforcement learning (RL) can be used to determine a structure for a complex tensor network. The agent makes incremental changes to a tensor network according to a policy model, where parameters of the policy model were trained using RL. The agent may use a cost function to assess the changes, e.g., to determine whether or not to keep a particular modification. In some cases, tensor networks determined using the RL agent can be used to train a model that can more efficiently select a structure for a complex tensor network.

### TECHNICAL FIELD

This disclosure relates generally to tensor network algorithms, and more specifically, to using reinforcement learning and graph neural networks and related techniques for designing efficient and accurate tensor network structures.

### BACKGROUND

Simulation of chemistry and materials science is useful in many technology areas, including drugs, catalysis, batteries, semiconductors, alloys, and fuels. Such simulations can be very demanding on computing hardware.

Tensor network (TN) algorithms, such as the density-matrix renormalization group (DMRG) algorithm, are an important class of algorithms for solving especially difficult problems, including problems in chemistry and materials science. For example, TN algorithms are used to solve problems for materials with strongly correlated electron interactions. The choice of tensor network structure determines the efficiency (e.g., required floating point operations per iteration) and accuracy of the tensor network used for solving such complex problems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a reinforcement learning environment, in accordance with various embodiments.

FIG. 2 illustrates a first example tensor network, in accordance with various embodiments.

FIG. 3 illustrates a second example tensor network, in accordance with various embodiments.

FIG. 4 illustrates a third example tensor network, in accordance with various embodiments.

FIGS. 5A-5F illustrate an example tensor network with various changes made by an agent, in accordance with various embodiments.

FIG. 6 illustrates an example process for determining a tensor network structure using an RL agent, in accordance with various embodiments.

FIG. 7 illustrates an example tensor network system for structuring and solving a tensor network algorithm, in accordance with various embodiments.

FIG. 8 illustrates an example process of determining a tensor network structure and solving a tensor network algorithm using machine-learned models, in accordance with various embodiments.

FIG. 9 is a block diagram of an example computing device, in accordance with various embodiments.

### DETAILED DESCRIPTION

Overview

As noted above, tensor networks can be used to solve various problems, such as simulating physical materials. A tensor network (TN) is a network of nodes, in which the nodes are connected through edges. A node represents a scalar or tensor. A scalar may be a single data point. A tensor is a data structure having multiple data points across one or more dimensions. Example tensors include a vector, which is a one-dimensional tensor, and a matrix, which is a two-dimensional tensor. There can also be three-dimensional tensors and even higher dimensional tensors. A node in a TN may be associated with one or more edges. An edge can connect a node to another node, in which case the edge can also be referred to as a bond. The number of edges of extending from a node in the TN may equal the dimension of the node, i.e., the dimension of the tensor represented by the node. Furthermore, edges between nodes in a TN have a bond dimension, which refers to the dimension of the bond index between two tensors connected by the edge.

Algorithms performed using tensor networks begin with the important but complex choice of tensor network structure. The structure of the TN determines the required number of floating point operations per iteration, the total iterations required, and the model's accuracy. When designing a TN structure, it is desirable to have the TN be both accurate and efficient in terms of computing resources.

Currently, researchers may select a TN structure by using intuition based on past experience, or by optimizing over one parameter that is varied in a handful of numerical experiments. For example, in the DMRG algorithm, the only free parameter is typically the bond dimension, which is proportional to the size of a local tensor. Researchers tend to use a simple one-dimensional DMRG structure, and then try varying the bond dimension (which is set to be equal across all edges) until the answer converges. However, using intuition, or using a simple structure with minor variations, leaves most potential TN structures unexplored. The space of the potential TN structures is combinatorially large, and it is likely that, for a given problem, more resource-efficient and/or accurate TN structures exist that are not being discovered through the current processes of selecting or evaluating TN structures.

Various techniques for designing and using TN structures are described herein. In some embodiments, reinforcement learning (RL) is used to design a TN structure. A training process trains an RL agent that, given an initial TN structure, can make changes to the TN structure to improve the TN structure, e.g., make it more accurate and/or more efficient. The RL process involves learning policies and maximizing one or more rewards for the agent. A policy defines the way the agent behaves in the environment, which in this case, is the TN. For instance, the policy may determine one or more actions that a RL agent should take in an environment. The policy may include a function, such as a function of the agent's state, the agent's environment, other factors of the agent, or some combination thereof. The policy may be referred to as a policy model. A function in the policy can be a simple function or lookup table in the simplest cases, or it may involve complex function computations. The process of training the agent includes a process of modifying/training the policy model, e.g., by updating parameters in the policy model.

In general RL processes, rewards define the goal of a RL problem. At each iteration of the RL process, the action of the agent results in a reward. The agent's goal is to maximize the total reward it receives. The reward can distinguish between good (e.g., helpful or desired) actions and bad (e.g., unhelpful or undesired) actions taken by the agent. The reward may be the primary way for impacting the policy. For instance, if an action selected by the policy results in a low reward, the policy can be changed to select some other action for the agent in the same situation. The reward signal may indicate good actions of the agent in an immediate sense. For instance, each action of the agent results immediately in a reward.

In one embodiment, an efficient TN structure is designed for a single problem instance. In this case, the RL agent may be trained based on a cost function that maximizes a reward by rewarding various factors, e.g., enabling parallel processing of the TN structure, reducing cache interactions, reducing convergence time, and reducing a number of computing operations needed to contract the TN. The RL agent may make a series of incremental changes to the TN. An incremental change to a TN may be a change to the TN involving a single node or a single edge between two nodes. For example, in each step, the RL agent may remove or add a bond between a selected pair of nodes in the TN, add a node in the TN, remove a node in the TN, or change a size of a bond in the TN. The RL agent may make one or more changes and re-calculate the cost function until a convergence criterion for the cost function is reached. The convergence criterion may indicate a threshold reward of the agent or indicate that the agent's actions in the environment, which are determined based on the latest policy model, are sufficiently good, i.e., the agent is sufficiently trained.

In other embodiments for designing an efficient TN structure given a problem instance, a model trained based on a large dataset is used to determine a TN structure for a particular problem. Pairs of problems and TN structures are used to train the model, where in each pair, the TN structure is known or expected to be efficient and accurate for solving the problem. In some embodiments, the TN structures in the training set are determined using the RL algorithm described above. The problem—TN structure pairs may be used to train a graphical neural network (GNN) or another type of neural network (NN). The GNN or NN model is trained to receive a problem (e.g., a mathematical description of a physical material, such as a molecule, and a property of interest, such as material strength) and determine a TN structure for solving the problem.

In some embodiments, a second model is trained to determine estimates for tensor values within the TN structure. For example, the second model may be a second GNN or second NN. The second model receives the problem and the TN structure output by the first model, and outputs initial estimates for tensor values within the TN structure. Having the initial estimates can speed the process of collapsing the TN structure to determine the solution to the problem.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example Reinforcement Learning Environment

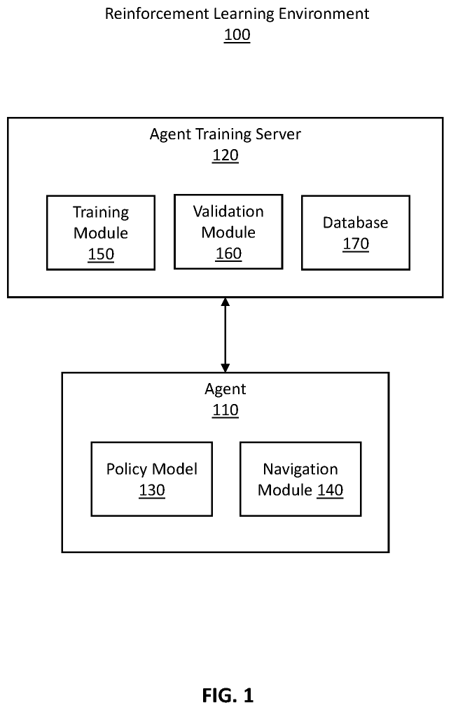

FIG. 1 illustrates a reinforcement learning (RL) environment 100, in accordance with various embodiments. The RL environment 100 includes an agent 110 and an agent training server 120. The agent 110 and agent training server 120 may be connected by a network, not specifically illustrated in FIG. 1. In other embodiments, the RL environment 100 may include fewer, more, or different components. For instance, the RL environment 100 may include multiple agents 110 in a multi-agent RL environment, or multiple different agents 110 trained for different goals (e.g., trained based on different cost functions). As another example, the agent 110 and agent training server 120 may be within a single server system or other computing system, or the agent 110 and/or agent training server 120 may be distributed across multiple servers or computing systems.

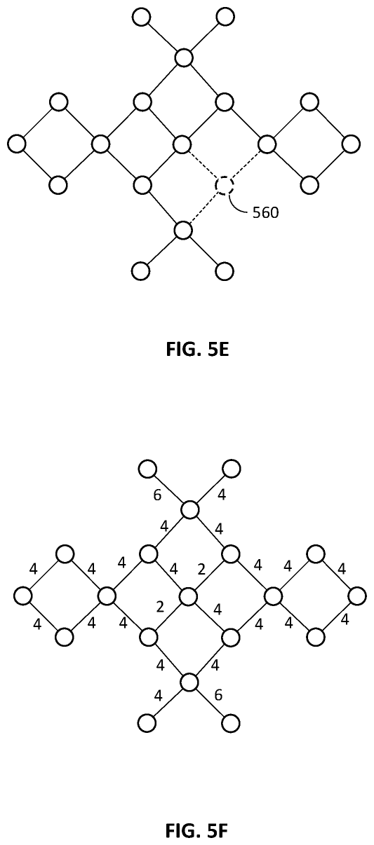

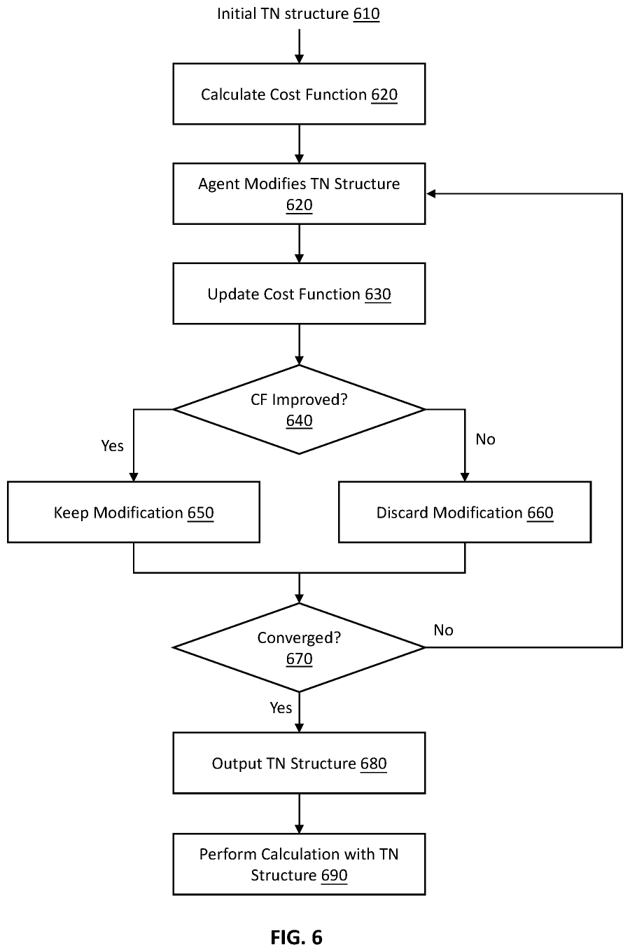

The agent 110 is trained by the agent training server 120 to carry out a task for accomplishing a goal. In various embodiments, the agent 110 is trained by the agent training server 120 to determine a TN structure for a particular problem. An agent 110 is capable of perceiving its environment (e.g., a portion of a TN structure, or a full TN structure) and taking actions in the environment with the purpose of accomplishing the goal, e.g., outputting an efficient and accurate TN structure. Various actions that the agent 110 may perform on a TN structure are described with respect to FIGS. 5A-5F. A method for using the agent 110 to determine a TN structure for a problem is described with respect to FIG. 6.

In various embodiments, the agent 110 is trained to take actions that can maximize one or more reward signals. For instance, the agent 110 includes a policy model 130 that controls operations and functionality of the agent 110. The policy model 130 may be a computing system, e.g., a neural network, that has been trained to control the operations and functionality of the agent 110 based on reward signals. The policy model 130 may receive data sensed by the navigation module 140, described below. In various embodiments, based on data from the navigation module 140 and the policy learned by the agent training server 120, the policy model 130 determines actions that the agent 110 will take to maximize a reward signal. In an example, the policy model 130 determines whether the agent 110 adds a node in the TN based on a reward signal that incorporates both a contribution of the additional node to the task and a cost of the additional node. The cost of the additional node may include, for example, additional computational resources for collapsing the TN.

In some embodiments, the agent 110 includes a navigation module 140 that enables the agent 110 to move within the TN environment, e.g., to different nodes of the TN. The navigation module 140 may move the agent 110 autonomously within the TN. In some embodiments, the navigation module 140 directs movement of the agent 110 according to the policy model 130. The navigation module 140 may determine a state of the agent 110, e.g., a position within a TN. The navigation module 140 may sense the environment of the agent 110, e.g., if the agent 110 is at a given node, the navigation module 140 senses bonds coupled to the node, and other nodes coupled to the given node via the bonds.

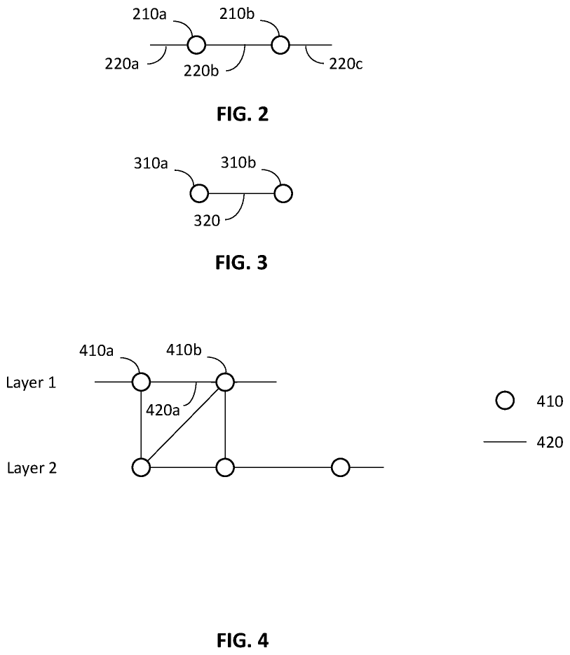

More specifically, in one embodiment, the local environment of the agent 110 detected by the navigation module 140 includes two nodes connected by a bond, and the policy model 130 computes singular values of the product of the two tensors connected by the bond. As noted above and described further below, a bond is an edge between two nodes in a TN structure. The policy model 130 may use these singular values to determine whether a bond size is too small or larger than necessary; for instance, very small singular values indicate that a bond size can likely be reduced. In another embodiment, the local environment of the agent 110 detected by the navigation module 140 includes a set of local nodes (e.g., all nearest and next-nearest nodes). The policy model 130 calculates an algebraic difference between contracting a set of unmodified local nodes and performing the same local contraction in a modified environment, e.g., one in which the TN structure has been modified. Contracting a TN involves performing a sequence of pairwise contractions of nodes within the TN, where each contraction is an inner product. Example tensor contractions are described below with respect to FIGS. 2-4.

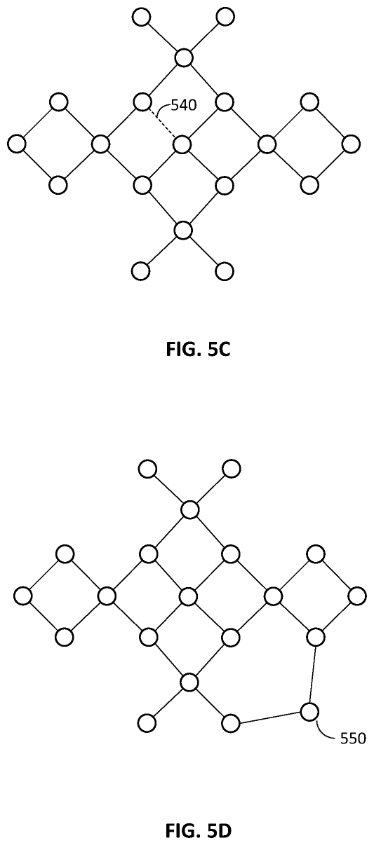

The agent 110 may operate within a TN structure to make improvements to the TN structure until a convergence criterion associated with one or more cost functions is reached. The convergence criterion may be, for example, convergence of the cost function, e.g., the cost function changes by less than a specified value in response to one or more incremental changes by the agent 110. Example cost functions are described further with respect to FIGS. 4 and 6. In some embodiments, the policy model 130 and/or navigation module 140 of the agent 110 may be changed to avoid traps, e.g., local optimizations of the TN structure as opposed to a global optimization. For example, the navigation module 140 may periodically “jump” from one part of a TN structure to another part of the TN structure (e.g., from a first node to a second, non-adjacent node) to avoid optimizing a particular region in isolation from other regions.

The agent training server 120 trains the agent 110 to accomplish the goal of the RL system. More specifically, the agent training server 120 trains the policy model 130 by using RL and transmits the trained policy model 130 to the agent 110, which stores the trained policy model 130. The agent training server 120 may continuously train the policy model 130 based on new training data, e.g., data received from the agent 110. The agent training server 120 may periodically release a new policy model 130 to the agent 110 to replace an existing policy model in the agent.

In some embodiments, the agent training server 120 determines the goal of the agent 110. For instance, the agent training server 120 may receive a request for an agent tuned to generate a TN structure that meets one or more specific goals, e.g., reducing cache interactions, or having a threshold accuracy. The agent training server 120 can train or adjust a policy model 130 based on the request. For example, the agent training server 120 may train multiple different policy models 130 according to different cost functions, e.g., a first policy model trained based on a cost function that has a relatively high weight for an accuracy criterion, a second policy model trained based on a cost function that favors reduced cache interactions, etc. The agent training server 120 can select one of the trained policy models based on a particular request.

The agent training server 120 includes a training module 160, a validation module 160, and a database 170. The training module 150 trains the policy model 130 of the agent 110. The training module 150 may train the policy model 130 using a training dataset. The training dataset may be a set of problems for the agent 110 to determine TN structures for. The training module 150 may also have an initial policy model 130 that is adjusted based on the training. For a given training problem, the training module 150 makes one or more incremental changes to a TN structure and assesses the impact of the changes, e.g., the effects of the change(s) on a cost function. The training module 150 adjusts the parameters of the policy model, e.g., to encourage the policy model to make changes that were beneficial (as indicated by the cost function), and to discourage the policy model from making changes that were not beneficial. Various example changes that the agent 110 may make according to the policy model 130 are described with respect to FIGS. 5A-5F.

Parameters of the policy model may include criteria for making a particular change in the TN structure. For example, the policy model may include a threshold bond size, and if a bond is below the threshold, the agent 110 removes or considers removing the bond. This threshold is a parameter that can be adjusted by the training module 150. In some embodiments, an element of randomness is incorporated into the policy model. Another example parameter is a likelihood with which the agent 110 makes a particular change, and the likelihood is a parameter that can be adjusted by the training module 150. For example, if a policy has a 50% likelihood of removing a bond (if the policy's bond removal criteria are met), the agent 110 may generate or access a random number between 0 and 1 and, if the random number is above 0.5, the agent 110 removes the bond. The training module 150 can adjust a likelihood upward (e.g., to 70%) or downward (e.g., to 30%) to make it more or less likely that the agent 110 makes a change.

Tuning the policy model in this way makes the agent 110 operating according to the policy model more likely to find an optimal or satisfactory TN structure and/or to find the optimal TN structure (or a sufficiently satisfactory TN structure) more quickly. Different machine learning techniques—such as linear support vector machine (linear SVM), boosting for other algorithms (e.g., AdaBoost), neural networks (e.g., convolutional neural network), logistic regression, naïve Bayes, memory-based learning, random forests, bagged trees, decision trees, boosted trees, or boosted stumps—may be used by the training module 150 in different embodiments.

In some embodiments, a part of the training dataset may be used to initially train the policy model, and the rest of the training dataset may be held back as a validation subset used by the validation module 160 to validate performance of a trained policy model. The portion of the training dataset not including the validation subset may be used to train the policy model. The validation module 160 verifies accuracy of the trained policy model. In some embodiments, the validation module 160 inputs samples in a validation dataset into the policy model and uses the outputs of the policy model to determine the model accuracy. In some embodiments, a validation dataset may be formed of some or all the samples in the training dataset. Additionally or alternatively, the validation dataset includes additional samples, other than those in the training datasets. In some embodiments, the validation module 160 determines an accuracy score of TN structures obtained according to the policy model. For example, the validation module 160 receives TN structures produced by the agent 110 according to the policy model for a set of sample problems having known or verified solutions. The verification module 160 compares the known solutions to the sample problems to solutions determined using the TN structures produced by the agent 110 (e.g., calculating a maximum or average difference to the known solutions) to assess the accuracy of the trained policy module.

The validation module 160 may compare the accuracy score with a threshold score. In an example where the validation module 160 determines that the accuracy score of the policy model is lower than the threshold score, the validation module 160 instructs the training module 150 to re-train the policy model. In one embodiment, the training module 150 may iteratively re-train the policy model until the occurrence of a stopping condition, such as the accuracy measurement indication that the policy model may be sufficiently accurate, or a number of training rounds having taken place.

The agent training server 120 may further include a database 170 that can store information about the agent 110, such as agent identification information, profile records, behavioral patterns, and so on. As noted above, in some embodiments, the agent training server 120 may train multiple different agents 110 with different policy models, e.g., to reward different features of a TN structure. The database 170, or another database, may store routes, locations, etc. permitted for use by the agents 110.

While not specifically shown, one or more third-party systems may communicate with RL environment 100 through a network. For instance, a third-party system may send a service request to the RL environment 100, e.g., directly to the agent 110, or to an RL interface server. The service request may specify a problem for which a suitable TN structure is desired. For example, the problem may include a mathematical model of a physical material (e.g., a molecular structure) and one or more properties of interest (e.g., material strength, response to light, etc.). In some cases, the problem may include additional information, such as data describing a light source, a voltage or current applied to the material, etc. In some embodiments, the service request may include an initial TN structure for the agent 110 to start from. Alternatively, the agent 110 may select a default initial TN structure, or select an initial TN structure from a set of initial TN structures (e.g., based on the data describing the material, data describing a goal of the TN structure, or other data received in the request). The agent 110 traverses the initial TN structure and makes changes to the TN structure based on the cost function. The RL environment 100 (e.g., the agent 110 or an RL interface server) returns the final TN structure to the third-party system.

Example Tensor Networks

FIG. 2 illustrates a first example tensor network, in accordance with various embodiments. FIG. 2 includes two nodes, 210a and 210b, and three edges 220a, 220b, and 220c. FIG. 2 represents matrix-matrix multiplication, where each of the nodes 210a and 210b represent a matrix, and the edge 220b represents a bond between the matrices 210a and 210b. In general, each node represents a tensor, and the number of edges extending from the node indicates the rank of the tensor. For example, a node having one bond extending therefrom is a vector (i.e., a rank-1 tensor), a node having two bonds extending therefrom (like the nodes 210a and 210b) is a matrix (i.e., a rank-2 tensor), a node having three bonds extending therefrom is a rank-3 tensor, and so forth.

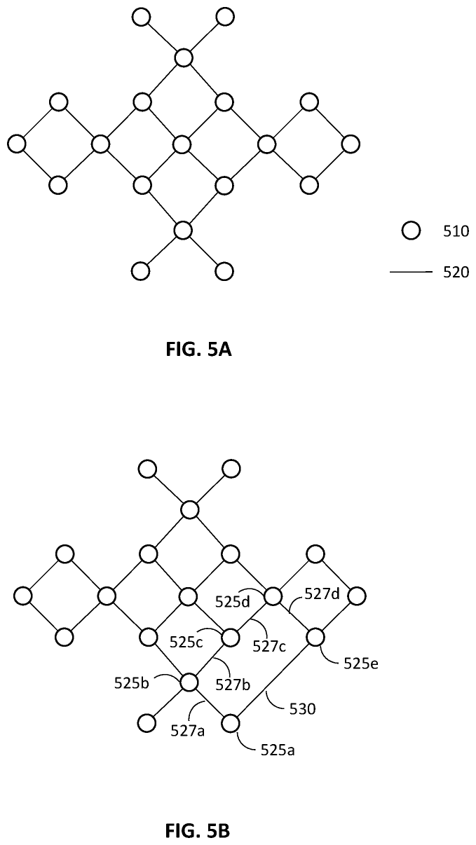

FIG. 3 illustrates a second example tensor network, in accordance with various embodiments. FIG. 3 also includes two nodes, 310a and 310b, and one edge 320 between the nodes 310a and 310b. FIG. 3 represents a vector-vector contraction (inner product), where the nodes 310a and 310b each represent a vector. In this example, the node 310a can be denoted vector v, and the node 310b can be denoted vector w. The inner product of the two nodes 310a and 310b may be represented as:

$$u = v w = {\sum }_{j = 1}^{n} {v}_{j} {w}_{j}$$

If each tensor is a vector, as in the example of FIG. 3, the contraction of the tensors is also referred to as a dot product. Tensor contraction is a generalization of the dot product. In general, tensor contraction consists of setting two unlike indices equal to each other and then summing using the Einstein summation convention. In tensor index notation, to contract two tensors with each other, one places them side by side as factors of the same term. This implements the tensor product, yielding a composite tensor. Contracting two indices in this composite tensor implements the contraction of the two tensors.

As a further example, returning to FIG. 2, each of the matrices 210a and 210b can be represented as tensors of type (1, 1) with the first index being contravariant and the second index being covariant. If Λ_{β}^{α} represents the components of the matrix 210a and M_{γ}^{β} represents the components of the matrix 210b, the contraction of the matrices 210a and 210b is given by:

N_{γ}^{α}=Λ_{β}^{α}M_{γ}^{β}

FIG. 4 illustrates a third example tensor network, in accordance with various embodiments. FIG. 4 is a more complex tensor network having five nodes 410 and nine edges 420. The nodes 410 represent tensors having different ranks, e.g., the node 410a is a rank-3 tensor, and the node 410b is a rank-4 tensor. Again, each edge 420 represents a contraction operation between the two nodes 410 connected to the edge 420. For example, the edge 420a represents a contraction of the nodes 410a and 410b. The nodes 410 are grouped into two layers, labelled layer 1 and layer 2 in FIG. 4. In most cases, a TN structure can be fully described as an undirected graph whose edges are labelled with integer-valued bond dimensions or bond sizes, where the bond dimension refers to the dimension of the bond index connecting one tensor in the TN to a neighboring tensor.

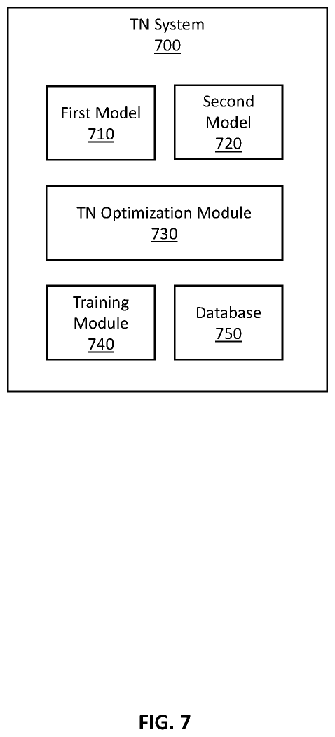

A final TN structure that includes multiple layers (e.g., two layers, as shown in FIG. 4, or more layers, such as the example TN structures shown in FIGS. 5A-5F) within the TN structure may indicate that the TN structure was determined using a RL process, e.g., the process described with respect to FIG. 6, or another machine-learning process, e.g., the process described with respect to FIG. 7. This is because a complex structure with multiple layers is not typically tested or selected by human-directed TN selection processes. More generally, irregular TN structures can indicate that a RL process or other machine-learning process was used. Irregular TN structures may be TN structures that do not have a lattice pattern, or that do not have a bond size pattern (e.g., a single bond size, or another clear pattern in the bond sizes).

Evaluating or solving a particular problem (e.g., solving for a property of a material input into a TN) may involve a TN algorithm performed using the determined TN structure. For example, one TN algorithm is fully contracting a complex tensor network, such as the tensor network illustrated in FIG. 4, down to a single tensor. As described above, contracting the tensor network involves performing a sequence of pairwise contractions of nodes within the TN, where each contraction is an inner product. The properties of the underlying TN structure determine the efficiency of the contraction process. Efficiency can be measured in various ways, such as number of floating point operations (FLOPS) and memory usage. One common obstacle in contracting TNs is that memory requirements can rapidly increase (sometimes exponentially) during the course of the contraction, if the ranks of the intermediate tensors are higher than the ranks of the original tensors. This is one obstacle for which better-designed TN structures may be a solution. Another example TN algorithm performed after the TN structure is determined is a density matrix renormalization group (DMRG) sweep procedure for minimizing energy.

A cost function can be calculated for a particular TN algorithm performed on a TN structure. While and/or after the TN algorithm is completed, a cost function is calculated based on specified factors, which can be selected and weighted based on hardware constraints (e.g., computing resources, memory availability, memory bandwidth, etc.), accuracy requirements, and/or other factors. The cost function may consider, for example, convergence time of the TN algorithm, number of computing operations needed to perform the TN algorithm (e.g., number of FLOPs to contract the TN), ability to perform processing steps in parallel (e.g., allowing bonds between different nodes to be contracted in parallel), memory usage and constraints (e.g., amount of memory needed, number of cache interactions), data re-use, and accuracy with respect to a true solution. The cost function may be re-calculated each time the agent 110 modifies the TN structure.

Example Agent Changes to Tensor Networks

FIGS. 5A-5F illustrate an example tensor network with various changes made by the agent 110, in accordance with various embodiments. FIG. 5A illustrates an initial tensor network that includes nodes 510 and bonds 520. As described with respect to FIGS. 2-4, the nodes 510 represent tensors having different ranks. The edge 520 represents bonds between the tensors represented by the nodes 510. The nodes 510 are grouped into various layers with different numbers of nodes 510 in different layers.

As described above, the agent 110 traverses the TN and makes changes to the TN according to the policy model 130. The agent 110 makes changes that improve the cost function, as described above. FIGS. 5B-5F visually illustrate example changes to a TN that may be made by the agent 110.

FIG. 5B illustrates an example of adding a bond 530 between two nodes 510. The bond 530 was not present in the initial TN illustrated in FIG. 5A. The agent 110 may determine to add a bond 520 between two nodes 510 if the shortest path between those two nodes contains large bond sizes, e.g., each of the bonds along the shortest path is over a threshold bond size. The threshold bond size may be one parameter learned by the training module 150, as described with respect to FIG. 1. For example, the TN illustrated in FIG. 5B includes 5 nodes, 525a, 525b, 525c, 525d, and 525e, connected by bonds 527a, 527b, 527c, and 527d (e.g., bond 527a connects nodes 525a and 525b, bond 527b connects nodes 525b and 525c, etc.). If each of the bond sizes of 527a-527d is larger than a given threshold, then the agent 110 may add the bond 530 between nodes 525a and 525e. This is because the larger intermediate bonds implies that there might be substantial entanglement between bonds 527a, 527b, 527c, and 527d.

FIG. 5C illustrates an example of removing a bond 540 between two nodes. The bond 540 was present in the initial TN illustrated in FIG. 5A, and the dashed line indicates that the bond 540 is removed. The agent 110 may determine to remove a bond 520 if the bond size is small, e.g., below a certain threshold. The threshold bond size for removing a bond may be another parameter learned by the training module 150.

FIG. 5D illustrates an example of adding a node 550. In this example, the node 550 is bonded to two existing nodes in the initial TN illustrated in FIG. 5A. The agent 110 may determine to add a node 510 if the shortest path between the two nodes being connected to the new node contains abnormally large bond sizes (e.g., as described above with respect to FIG. 5B), and the problem requires that certain constraints be preserved, for example the number of particles (e.g., electrons) in the material being modeled. A threshold bond size for adding a node may be additional parameters learned by the training module 150. Other criteria (e.g., problem constraints) may be provided by a user or determined based on the problem statement.

FIG. 5E illustrates an example of removing a node 560 and edges coupled to the node 560. The node 560 was present in the initial TN illustrated in FIG. 5A. The dashed circle indicates that the node 560 is removed, and the dashed lines indicate that bonds to the node 560 are removed. The agent 110 may determine to remove a node 560 if all the edges connected to node 560 have small bond sizes, e.g., below a certain threshold. The threshold bond size used to determine whether to remove a node may be another parameter learned by the training module 150.

FIG. 5F illustrates an example of changing bond sizes between various nodes 510. While not specifically shown, each edge 520 has a bond dimension. In this example, each bond dimension in the initial TN structure of FIG. 5A may be 4. In FIG. 5F, certain bond dimensions are increased to 6, while other bond dimensions were reduced to 2. For example, the agent 110 may determine to reduce a bond dimension if a singular value decomposition analysis indicates that the smallest singular value is smaller than a given threshold. Singular value decomposition analysis involves computing singular values of the product of the two tensors connected by the bond, as described with respect to FIG. 1. The agent 110 may determine to increase a bond dimension if a singular value decomposition analysis reveals that the smallest singular value is larger than a given threshold. The threshold for the smallest singular value may be another parameter learned by the training module 150.

The TN structure shown in FIG. 5F includes different bond sizes. A final TN structure that includes different bond sizes (e.g., two different bond sizes, three different bond sizes, four different bond sizes, etc.) throughout the TN structure may indicate that the TN structure was determined using a RL process, e.g., the process described with respect to FIG. 6, or another machine-learning process, e.g., the process described with respect to FIG. 7. This is because a complex structure with multiple different bond sizes is not typically tested or selected by human-directed TN selection processes.

The agent 110 may make other changes to the TN structure not illustrated in FIG. 5. For example, the policy model 130 may cause the agent 110 to combine two nodes, e.g., if mutual information between the two nodes is greater than a certain level.

Example Agent-LED Process for Determining Tensor Network Structure

FIG. 6 illustrates an example process for determining a tensor network structure using an RL agent, in accordance with various embodiments. The RL environment 100 receives an initial TN structure 600, e.g., the initial TN structure illustrated in FIG. 5A. The agent 110 calculates 610 a cost function for the initial TN structure 600. The cost function may be a cost for performing a TN algorithm on the TN structure 600, as described above.

The agent 110 modifies 620 the TN structure. The modification may be a single incremental change to the TN structure. For example, the agent 110 make any one of the modifications described with respect to FIGS. 5B-5F. The agent 110 then re-calculates 630 the cost function.

The agent 110 determines 640 whether the cost function has improved based on the modification made at step 620. For example, the agent 110 may have a goal of minimizing a cost function, and the agent 110 determines whether the computed value for the cost function is lower than a previous value. The reward can be optimized by minimizing the cost function. If the cost function has improved, the agent 110 keeps 650 the modification made at step 620. If the cost function has not improved, the agent 110 discards 660 the modification made at step 620. After discarding the modification, the agent 110 returns to step 620, and makes another (different) modification to the TN structure.

If the cost function has improved, after keeping 650 the modification, the agent 110 determines whether the process has converged, e.g., whether the cost function has met a convergence criterion. For example, the convergence criterion may indicate that the last modification, or a certain number of modifications, have made improvements to the cost function below a certain threshold. For example, if each of the last 10 changes to the cost function were below a certain threshold, or an average of the last 10 changes to the cost function were below a certain threshold, the agent 110 may determine that the process has converged.

If the process has not converged, the agent 110 returns to step 620, and makes another (different) modification to the TN structure. If the process has converged, the agent 110 or RL environment 100 outputs the determined TN structure. Computing circuitry receiving the TN structure may perform 690 a calculation with the TN structure, e.g., to determine a property of a physical material modeled by the TN structure.

Example NN-Based TN Structure Selection and Solving

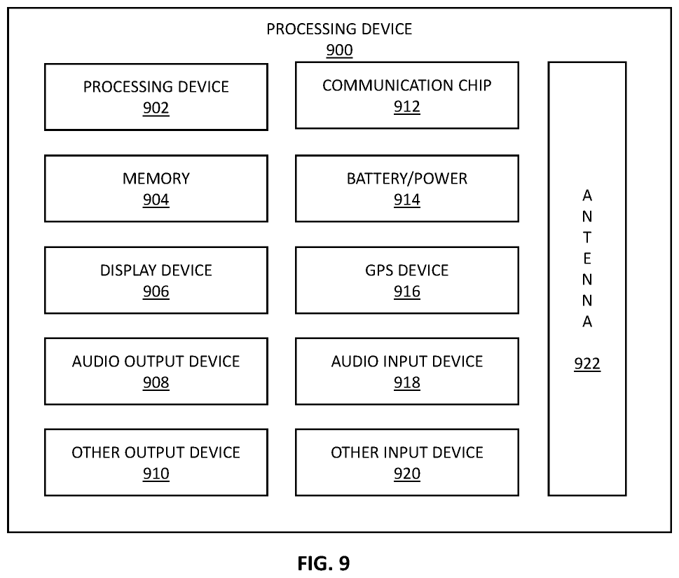

FIG. 7 illustrates an example tensor network system for structuring and solving a tensor network algorithm, in accordance with various embodiments. The system illustrated in FIG. 7 includes two models 710 and 720, a TN optimization module 730, a training module 740, and a database 750. The TN system 700 and/or one or more components of the TN system 700 may be implemented by one or more computing devices, e.g., the processing device illustrated in FIG. 9.

The first model 710 is a machine-learned model for generating a TN structure. In particular, the first model 710 can determine and output a TN structure for solving a problem based on data describing a problem instance. The problem instance may be a set of values describing the problem. For example, the set of values describing the problem may include a mathematical description of a physical material, such as a molecule, and a property of interest, such as material strength. The first model 710 may output an embedding describing the determined TN structure. In other embodiments, the first model 710 may output a different numerical description of the determined TN structure.

The second model 720 is machine-learned model to determine values for tensors within a given TN structure. To solve a problem represented by a TN, various inputs are provided to the TN (e.g., initial values for one or more tensors within the TN), and these inputs and the TN structure may be used to compute values for other tensors within the TN. After the tensor values are determined, a TN algorithm, such as contracting the TN, can be performed. Determining the tensor values across the TN is a computationally-intensive task, and using the second model 720 to determine initial estimates for the values of some or all tensors within the TN structure can speed the process of performing a TN algorithm based on the TN structure, e.g., contracting the TN.

The optimization module 730 receives the problem instance, data describing a TN structure (e.g., an embedding output by the first model 710), and the estimated tensor values for the TN structure (e.g., tensor values output by the second model 720). The optimization module 730 can determine and output a solution to the problem instance based on the TN structure and the estimated tensor values. For example, the optimization module 760 determines optimized values for tensors across the TN structure represented by the embedding based on the estimated values provided by the second model 720. The optimization module 730 then determines a solution to the problem input to the TN structure, e.g., by contracting the TN based on the optimized values. In some embodiments, the optimization module 760 includes a first sub-module to optimize the tensors values in the TN, and a second sub-module to determine the solution based on the optimized tensors, e.g., a second sub-module to contract the TN structure.

The training module 740 may train the first model 710 and the second model 720 based on training data in the database 750. In some embodiments, a first training module trains the first model 710, and a second training module trains the second model 720. The training module 740 may train the first model 710 and/or the second model 720 using a neural network (NN), such as a graphical neural network (GNN). In other embodiments, the training module 740 may train the first model 710 and/or the second model 720 using a convolutional neural network (CNN) or another type of NN. The training module 740 may utilize optimization processes, such as stochastic gradient decent, during training of the models 710 and 720. The training module 740 may adjust either or both of the models 710 and 720 after an initial training process, e.g., based on additional data in the database 750.

The database 750 stores training data that includes pairs of problems and corresponding TN structures for training the first model 710. In each pair of the training data set, the TN structure is known or expected to be both efficient and accurate for solving the problem. The TN structures in the training set may be relatively complex TN structures, such as the TN structures illustrated in FIGS. 4 and 5. In some embodiments, at least a portion of the TN structures in the training set are determined using the RL process described with respect to FIGS. 1 and 6.

The database 750 further stores training data that includes problems, TN structures, and values for the tensors in the TN structures for training the second model 720. In each instance of the training data, the TN structure is known or expected to be both efficient and accurate for solving the problem, as with the first model 710. Furthermore, the values for the tensors in the TN structure may be by an algorithm for solving the problem represented by the TN structure, whether the algorithm first computes intermediate values and then computes an answer to the problem based on the intermediate values. In some embodiments, at least a portion of the TN structures and associated TN values in the training set are determined using the RL process described with respect to FIGS. 1 and 6. The training set for training the second model 720 can include some or all of the pairs of problems and TN structures used to train the first model 710.

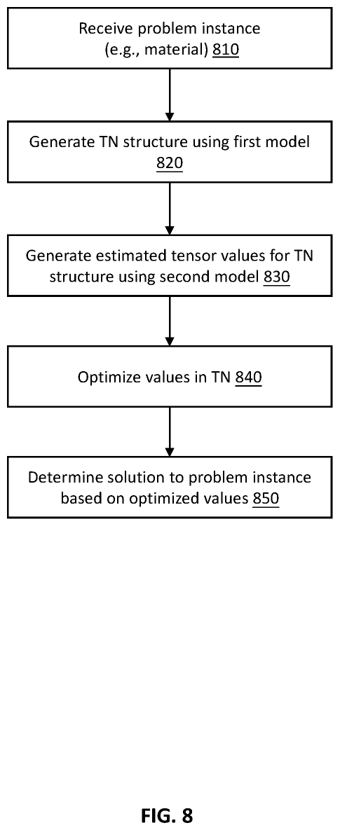

FIG. 8 illustrates an example process of determining a tensor network structure and solving a tensor network algorithm using machine-learned models, in accordance with various embodiments. A TN system, e.g., the TN system 800, receives 810 a problem instance. As described above, the problem instance may be a set of values describing the problem, and may include a mathematical description of a physical material, such as a molecule, and a property of interest, such as material strength.

The TN system generates 810 a TN structure using a first model, e.g., the first model 710 described with respect to FIG. 7, The first model 710 may output an embedding describing the determined TN structure, or a different numerical description of the determined TN structure.

The TN system generates 830 estimated tensor values for the TN structure using a second model, e.g., the second model 720 described with respect to FIG. 7. The tensor values may be estimates for values of tensors within the TN structure determined in step 820.

The TN system optimizes values in the TN. For example, the optimization module 730 determines optimized values for the tensors within the TN (having the structure determined at step 820) based on the estimates determined at step 830 using the second model 720, as described with respect to FIG. 7.

The TN system (e.g., the optimization module 730 or another module) then determines 850 a solution to the problem instance based on the optimized values. For example, the TN system performs a TN algorithm, such as contracting the TN, on the TN having the optimized tensor values. The result of the TN algorithm (e.g., a single tensor) represents a solution to the problem instance. The result may be provided by the TN system to a user, e.g., a user that input the problem instance.

Example Computing Device

FIG. 9 is a block diagram of an example computing system for use as any of the components or sub-components of FIGS. 1 and/or 7, in accordance with various embodiments. A number of components are illustrated in FIG. 9 as included in the computing system 900, but any one or more of these components may be omitted or duplicated, as suitable for the application. In some embodiments, some or all of the components included in the computing system 900 may be attached to one or more motherboards. In some embodiments, some or all of these components are fabricated onto a single system on a chip (SoC) die. Additionally, in various embodiments, the computing system 900 may not include one or more of the components illustrated in FIG. 9, but the computing system 900 may include interface circuitry for coupling to the one or more components. For example, the computing system 900 may not include a display device 906, but may include display device interface circuitry (e.g., a connector and driver circuitry) to which a display device 906 may be coupled. In another set of examples, the computing system 900 may not include an audio input device 918 or an audio output device 908, but may include audio input or output device interface circuitry (e.g., connectors and supporting circuitry) to which an audio input device 918 or audio output device 908 may be coupled.

The computing system 900 may include a processing device 902 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 902 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing system 900 may include a memory 904, which may itself include one or more memory devices such as volatile memory (e.g., DRAM), nonvolatile memory (e.g., read-only memory (ROM)), flash memory, solid hidden state memory, and/or a hard drive. In some embodiments, the memory 904 may include memory that shares a die with the processing device 902. In some embodiments, the memory 904 includes one or more non-transitory computer-readable media storing instructions executable to perform operations for controlling the agent 110, agent training server 120, models 710 or 720, optimization module 730, training module 740, or other devices to carry out the processes described herein. The instructions stored in the one or more non-transitory computer-readable media may be executed by the processing device 902.

In some embodiments, the computing system 900 may include a communication chip 912 (e.g., one or more communication chips). For example, the communication chip 912 may be configured for managing wireless communications for the transfer of data to and from the computing system 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.8 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 912 may operate in accordance with a Global System for Mobile Communication (GSM), GPRS, Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing system 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as GPS, EDGE, GPRS, CDMA, WiMAX, LTE, EV-DO, or others. In some embodiments, a first communication chip 912 may be dedicated to wireless communications, and a second communication chip 912 may be dedicated to wired communications.

The computing system 900 may include battery/power circuitry 914. The battery/power circuitry 914 may include one or more energy storage devices (e.g., batteries or capacitors) and/or circuitry for coupling components of the computing system 900 to an energy source separate from the computing system 900 (e.g., AC line power).

The computing system 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing system 900 may include an audio output device 908 (or corresponding interface circuitry, as discussed above). The audio output device 908 may include any device that generates an audible indicator, such as speakers, headsets, or earbuds, for example.

The computing system 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing system 900 may include a GPS device 916 (or corresponding interface circuitry, as discussed above). The GPS device 916 may be in communication with a satellite-based system and may receive a location of the computing system 900, as known in the art.

The computing system 900 may include an other output device 910 (or corresponding interface circuitry, as discussed above). Examples of the other output device 910 may include an audio codec, a video codec, a printer, a wired or wireless transmitter for providing information to other devices, or an additional storage device.

The computing system 900 may include an other input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing system 900 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing system 900 may be any other electronic device that processes data.

### Select Examples

The following paragraphs provide various examples of the embodiments disclosed herein.

Example 1 provides a computer-implemented method for determining a structure for a tensor network, the method including calculating a cost function for a tensor network structure, the tensor network structure comprising a plurality of nodes and one or more bonds between at least some of the plurality of nodes; modifying the tensor network structure to generate a modified tensor network structure; re-calculating the cost function for the modified tensor network structure; determining, based at least on the re-calculated cost function, to output the modified tensor network structure; and outputting the modified tensor network structure.

Example 2 provides the method of example 1, where the modified tensor network structure includes a first bond and a second bond, the first bond having a different bond size from the second bond.

Example 3 provides the method of example 2, where the modified tensor network structure further includes a third bond, the third bond having a different bond size from either the first bond or the second bond.

Example 4 provides the method of example 1, where the modified tensor network structure has a first layer and a second layer, the first layer having a different structure from the second layer.

Example 5 provides the method of example 1, further including inputting one or more values representing a physical material into the modified tensor network structure; and receiving at least one output from the modified tensor network structure, the at least one output representing a property of the physical material.

Example 6 provides the method of example 1, where modifying the tensor network structure includes at least one of adding a node to the tensor network structure; and removing a node from the tensor network structure.

Example 7 provides the method of example 1, where modifying the tensor network structure includes at least one of adding a bond between a pair of nodes in the tensor network structure; and removing a bond between a pair of nodes in the tensor network structure.

Example 8 provides the method of example 1, where modifying the tensor network structure includes changing a bond size between a pair of nodes in the tensor network structure.

Example 9 provides the method of example 1, where the cost function rewards tensor network structures that allow bonds between tensor nodes to be contracted in parallel.

Example 10 provides the method of example 1, where the cost function rewards tensor network structures that reduce interactions with a cache during contraction of the tensor network.

Example 11 provides the method of example 1, where the cost function rewards tensor network structures with greater computational efficiency in contraction of the tensor network, where computational efficiency is represented by at least one of convergence time and number of computing operations to contract the tensor network.

Example 12 provides the method of example 1, further including determining, based on the re-calculated cost function, that a cost function convergence criterion has been achieved; and outputting the modified tensor network structure in response to the cost function convergence criterion being achieved.

Example 13 provides a computer-implemented method, the method including determining a tensor network structure for a problem instance using a first machine-trained model, the first machine-trained model receiving data of the problem instance and outputting the tensor network structure, the tensor network structure comprising two or more tensors and one or more bonds between at least some of the plurality of tensors; determining one or more values for at least one of the plurality of tensors using a second machine-trained model, the second machine-trained model receiving the data of the problem instance and the tensor network structure and outputting the one or more values; and determining a solution to the problem instance based on the tensor network structure and the one or more values.

Example 14 provides the method of example 13, where the first machine-trained model is a GNN.

Example 15 provides the method of example 14, where the second machine-trained model is a second GNN.

Example 16 provides the method of example 13, where the first machine-trained model is trained using pairs of input values and tensor network structures, and each tensor network structure has been verified to be an efficient tensor network structure for the respective input values.

Example 17 provides the method of example 16, where at least a portion of the tensor network structures for training the first machine-trained model are obtained using a RL agent trained to minimize a cost function.

Example 18 provides the method of example 17, where the cost function rewards tensor network structures that enable parallel processing during contraction of the tensor network structure; reduce interactions with a cache during contraction of the tensor network; reduce convergence time; or reduce a number of computing operations during of the tensor network. Contraction of the tensor network may include performing a sequence of pairwise contractions of pairs of tensors of the tensor network structure, a pairwise contraction comprising an inner product of a pair of tensors connected by a bond.

Example 19 provides the method of example 13, where the one or more values comprise one or more initial estimates for at least one of the plurality of tensors, and the method further comprises determining one or more optimized values for at least one of the plurality of tensors based on the one or more initial estimates.

Example 20 provides the method of example 19, further including calculating the data describing based on the second set of values based on the optimized values for the intermediate values in the tensor network structure.

Example 21 provides the method of example 13, where the problem instance comprises data representing a physical material, and the solution to the problem instance comprises data representing a property of the physical material.

Example 22 provides or more non-transitory computer-readable media storing instructions executable to perform operations for determining a structure for a tensor network, the operations including calculating a cost function for a tensor network structure, the tensor network structure comprising a plurality of nodes and one or more bonds between at least some of the plurality of nodes; modifying the tensor network structure to generate a modified tensor network structure; re-calculating the cost function for the modified tensor network structure; determining, based at least on the re-calculated cost function, to output the modified tensor network structure; and outputting the modified tensor network structure.

Example 23 provides the one or more non-transitory computer-readable media of example 22, where the modified tensor network structure includes a first bond and a second bond, the first bond having a different bond size from the second bond.

Example 24 provides the one or more non-transitory computer-readable media of example 23, where the modified tensor network structure further includes a third bond, the third bond having a different bond size from either the first bond or the second bond.

Example 25 provides the one or more non-transitory computer-readable media of example 22, where the modified tensor network structure has a first layer and a second layer, the first layer having a different structure from the second layer.

Example 26 provides the one or more non-transitory computer-readable media of example 22, the operations further including inputting one or more values representing a physical material into the modified tensor network structure; and receiving at least one output from the modified tensor network structure, the at least one output representing a property of the physical material.

Example 27 provides the one or more non-transitory computer-readable media of example 22, where modifying the tensor network structure includes at least one of adding a node to the tensor network structure; and removing a node from the tensor network structure.

Example 28 provides the one or more non-transitory computer-readable media of example 22, where modifying the tensor network structure includes at least one of adding a bond between a pair of nodes in the tensor network structure; and removing a bond between a pair of nodes in the tensor network structure.

Example 29 provides the one or more non-transitory computer-readable media of example 22, where modifying the tensor network structure includes changing a bond size between a pair of nodes in the tensor network structure.

Example 30 provides the one or more non-transitory computer-readable media of example 22, where the cost function rewards tensor network structures that allow bonds between tensor nodes to be contracted in parallel.

Example 31 provides the one or more non-transitory computer-readable media of example 22, where the cost function rewards tensor network structures that reduce interactions with a cache during contraction of the tensor network.

Example 32 provides the one or more non-transitory computer-readable media of example 22, where the cost function rewards tensor network structures with greater computational efficiency in contraction of the tensor network, where computational efficiency is represented by at least one of convergence time and number of computing operations to contract the tensor network.

Example 33 provides the one or more non-transitory computer-readable media of example 22, the operations further including determining, based on the re-calculated cost function, that a cost function convergence criterion has been achieved; and outputting the modified tensor network structure in response to the cost function convergence criterion being achieved.

Example 34 provides or more non-transitory computer-readable media storing instructions executable to perform operations for structuring a tensor network, the operations including determining a tensor network structure for a problem instance using a first machine-trained model; determining values for one or more tensors within the tensor network structure using a second machine-trained model; and determining a solution to the problem instance based on the tensor network structure and the values for the plurality of tensors within the tensor network structure.

Example 35 provides the one or more non-transitory computer-readable media of example 34, where the first machine-trained model is trained using a GNN.

Example 36 provides the one or more non-transitory computer-readable media of example 35, where the second machine-trained model is trained using a second GNN.

Example 37 provides the one or more non-transitory computer-readable media of example 34, where the first machine-trained model is trained using pairs of input values and tensor network structures, each tensor network structure being an efficient structure for the respective input values.

Example 38 provides the one or more non-transitory computer-readable media of example 37, where at least a portion of the tensor network structures for training the first machine-trained model are obtained using a RL agent trained to minimize a cost function.

Example 39 provides the one or more non-transitory computer-readable media of example 38, where the cost function rewards tensor network structures that enable parallel processing during contraction of the tensor network structure; reduce interactions with a cache during contraction of the tensor network; reduce convergence time; or reduce a number of computing operations during of the tensor network.

Example 40 provides the one or more non-transitory computer-readable media of example 34, where the values for the plurality of tensors within the tensor network structure comprise initial estimates for values within the tensor network structure, the method further comprising determining optimized values for the plurality of tensors in the tensor network structure.

Example 41 provides the one or more non-transitory computer-readable media of example 40, further including calculating the data describing based on the second set of values based on the optimized values for the intermediate values in the tensor network structure.

Example 42 provides the one or more non-transitory computer-readable media of example 34, the problem instance comprises data representing a physical material, and the solution to the problem instance comprises data representing a property of the physical material.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method for determining a structure for a tensor network, the method comprising:
calculating a cost function for a tensor network structure, the tensor network structure comprising a plurality of nodes and one or more bonds between at least some of the plurality of nodes;
modifying the tensor network structure to generate a modified tensor network structure;
re-calculating the cost function for the modified tensor network structure;
determining, based at least on the re-calculated cost function, to output the modified tensor network structure; and
outputting the modified tensor network structure.

2. The method of claim 1, further comprising:
inputting one or more values representing a physical material into the modified tensor network structure; and
receiving at least one output from the modified tensor network structure, the at least one output representing a property of the physical material.

3. The method of claim 1, wherein modifying the tensor network structure comprises at least one of:
adding a node to the tensor network structure; and
removing a node from the tensor network structure.

4. The method of claim 1, wherein modifying the tensor network structure comprises at least one of:
adding a bond between a pair of nodes in the tensor network structure; and
removing a bond between a pair of nodes in the tensor network structure.

5. The method of claim 1, wherein modifying the tensor network structure comprises changing a bond size between a pair of nodes in the tensor network structure.

6. The method of claim 1, wherein the cost function rewards tensor network structures that allow bonds between tensor nodes to be contracted in parallel.

7. The method of claim 1, wherein the cost function rewards tensor network structures that reduce interactions with a cache during contraction of the tensor network.

8. The method of claim 1, wherein the cost function rewards tensor network structures with greater computational efficiency in contraction of the tensor network, wherein computational efficiency is represented by at least one of convergence time and number of computing operations to contract the tensor network.

9. The method of claim 1, further comprising:
determining, based on the re-calculated cost function, that a cost function convergence criterion has been achieved; and
outputting the modified tensor network structure in response to the cost function convergence criterion being achieved.

10. A computer-implemented method comprising:
determining a tensor network structure for a problem instance using a first machine-trained model, the first machine-trained model receiving data of the problem instance and outputting the tensor network structure, the tensor network structure comprising two or more tensors and one or more bonds between at least some of the plurality of tensors;
determining one or more values for at least one of the plurality of tensors using a second machine-trained model, the second machine-trained model receiving the data of the problem instance and the tensor network structure and outputting the one or more values; and
determining a solution to the problem instance based on the tensor network structure and the one or more values.

11. The method of claim 10, wherein the first machine-trained model is a graph neural network (GNN).

12. The method of claim 10, wherein the first machine-trained model is trained using pairs of input values and tensor network structures, and each tensor network structure has been verified to be an efficient tensor network structure for the respective input values.

13. The method of claim 12, wherein at least a portion of the tensor network structures for training the first machine-trained model are obtained using a reinforcement learning (RL) agent trained to minimize a cost function.

14. The method of claim 13, wherein the cost function rewards tensor network structures that:
enable parallel processing during contraction of the tensor network structure;
reduce interactions with a cache during contraction of the tensor network;
reduce convergence time; or
reduce a number of computing operations during of the tensor network.

15. The method of claim 15, wherein contraction of the tensor network structure comprises:
performing a sequence of pairwise contractions of pairs of tensors of the tensor network structure, a pairwise contraction comprising an inner product of a pair of tensors connected by a bond.

16. The method of claim 10, wherein the one or more values comprise one or more initial estimates for at least one of the plurality of tensors, and the method further comprises determining one or more optimized values for at least one of the plurality of tensors based on the one or more initial estimates.

17. The method of claim 10, wherein the problem instance comprises data representing a physical material, and the solution to the problem instance comprises data representing a property of the physical material.

18. One or more non-transitory computer-readable media storing instructions executable to perform operations for determining a structure for a tensor network, the operations comprising:
calculating a cost function for a tensor network structure;
modifying the tensor network structure to generate a modified tensor network structure;
re-calculating the cost function for the modified tensor network structure;
determining, based at least on the re-calculated cost function, to output the modified tensor network structure; and
outputting the modified tensor network structure.

19. The one or more non-transitory computer-readable media of claim 18, the operations further comprising:
inputting one or more values representing a physical material into the modified tensor network structure; and
receiving at least one output from the modified tensor network structure, the at least one output representing a property of the physical material.

20. The one or more non-transitory computer-readable media of claim 18, wherein modifying the tensor network structure comprises at least one of:
adding a node to the tensor network structure; and
removing a node from the tensor network structure.

21. The one or more non-transitory computer-readable media of claim 18, wherein modifying the tensor network structure comprises at least one of:
adding a bond between a pair of nodes in the tensor network structure; and
removing a bond between a pair of nodes in the tensor network structure.

22. The one or more non-transitory computer-readable media of claim 18, wherein modifying the tensor network structure comprises changing a bond size between a pair of nodes in the tensor network structure.

23. The one or more non-transitory computer-readable media of claim 18, wherein the cost function rewards tensor network structures that allow bonds between tensor nodes to be contracted in parallel.

24. The one or more non-transitory computer-readable media of claim 18, wherein the cost function rewards tensor network structures that reduce interactions with a cache during contraction of the tensor network.

25. The one or more non-transitory computer-readable media of claim 18, wherein the cost function rewards tensor network structures with greater computational efficiency in contraction of the tensor network, wherein computational efficiency is represented by at least one of convergence time and number of computing operations to contract the tensor network.
